(19) United States
(12) Patent Application Publication
(10) Pub. No.: US 2016/0290021 A1
(43) Pub. Date: Oct. 6, 2016

(54) DOOR LATCH DEVICE FOR VEHICLE

(71) Applicant: AISIN SEIKI KABUSHIKI KAISHA, Aichi (JP)

(72) Inventor: Takashi NISHIO, Kariya-shi, Aichi-ken (JP)

(73) Assignee: AISIN SEIKI KABUSHIKI KAISHA, Kariya-shi, Aichi (JP)

(21) Appl. No.: 15/038,326

(22) PCT Filed: Aug. 28, 2014
(86) PCT No.: PCT/JP2014/072597

§ 371 Date: May 20, 2016

(30) Foreign Application Priority Data
Nov. 22, 2013 (JP) 2013-242124

(51) Int. Cl. E05B 85/26; E05C 19/12; E05C 3/12

(52) U.S. Cl. CPC E05B 85/26; E05C 3/124; E05C 19/12

(57) ABSTRACT

A door latch device for vehicle includes a pawl which is engageable with a latch which rotates in a door closing direction by engaging with a striker, and a pawl return spring elastically biases the pawl towards a position at which the pawl is engaged with the latch. The pawl return spring comprises a coiled spring portion and an extending arm. The coiled spring portion has the coil center at a position which is spaced from the rotation center of the pawl; and has the coil center at a position which is spaced from the rotation center of the pawl. The extending arm extends along the abutted surface of the pawl from one of end portions of the coiled spring portion. The extending arm is configured so as to abut against a shear plane which is spaced from a fracture surface having relatively high surface roughness in the abutted surface.

### TECHNICAL FIELD

The present invention relates to a door latch device for a vehicle.

### BACKGROUND ART

An example of a door latch device for vehicle is disclosed in WO 2011/102057 A1, This door latch device for vehicle is provided with a latch, a pawl, and a pawl return spring. The latch rotates in a door closing direction when engaging with a striker of a vehicle body side. The pawl is engageable with the latch. The pawl return spring is for elastically biasing the pawl towards the engaging position at which the pawl engages with the latch. The pawl return spring is configured so that its pawl side end abuts with the spring engaging portion of the pawl. In this case, when a vehicle door closes, the latch is pressed by the striker to rotate in the door closing direction, and the pawl is engaged with the latch so as to hold the vehicle door at a half-latched state or a fully-closed state. On the other hand, when a door handle is operated, the pawl rotates in a direction to release the engagement between the latch and the pawl against the elastic biasing force of the pawl return spring. As a result, the vehicle door becomes able to open.

### SUMMARY OF INVENTION

### Problem to be Solved by the Invention

In the above door latch device for vehicle, the supporting shaft for rotatably supporting the pawl and the mounting shaft for mounting the pawl return spring are arranged so as to be spaced from each other. Therefore, when the pawl is rotated about the supporting shaft while receiving the elastic biasing force of the pawl return spring, a slip occurs between an abutted surface of the spring engaging portion of the pawl and a pawl side end of the pawl return spring. In this case, if roughness of the abutted surface of the spring engaging portion of the pawl is large, the slip is easily prevented. Therefore, a problem that operability (operating performance) of the pawl when the pawl rotates is lowered can occur. In particular, if the pawl is made by press forming of a metal plate, the spring engaging portion contains fracture surface (irregular surface) having very large roughness, and therefore the above-mentioned problem is remarkably exhibited.

The present invention has been made in view of the problem. An object of the present invention is provide an effective technique for improving operability of the pawl in the door latch device for vehicle which includes a latch rotating in the door closing direction when engaging with a striker, a pawl engageable with the latch, a pawl return spring for elastically biasing the pawl towards an engaging position at which the pawl engages with the latch.

### Means for Solving the Problem

In order to solve the above-mentioned problem, a door latch device for vehicle of the present invention includes a latch, a pawl, and a pawl return spring. The latch is configured to be rotated in a door closing direction by engaging with a striker. The pawl is rotatable between a first position and a second position about a supporting shaft. The pawl prevents the latch from rotating in a door opening direction by engaging with the latch at the first position, and releases a prevention of a rotation of the latch in the door opening direction by releasing an engagement with the latch at the second position. The pawl return spring abuts against an abutted surface provided on the pawl so as to elastically bias the pawl towards the first position. This pawl return spring includes a coiled spring portion which is formed in a coiled state and has the coil center at a position which is spaced from the rotation center of the pawl, and an extending arm extends along the abutted surface of the pawl from one of end portions of the coiled spring portion.

According to the structure, when the pawl is rotated while receiving a elastically biasing force from the pawl return spring, a slip occurs between the abutted surface of the pawl and the extending arm of the pawl return spring. In this case, if roughness of the abutted surface is large, the slip is easily prevented. As a result, operability of the pawl when the pawl rotates is lowered. Therefore, in the present invention, the extending arm of the pawl return spring is configured so as to abut with the second area which is spaced from the first area having relatively high surface roughness. In other words, a slippery area (which has a low sliding resistance) of the abutted surface is selected for an area with which the extending arm contacts. As a result, the slip between the abutted surface of the pawl and the extending arm of the pawl return spring is hardly prevented, and thereby operability of the pawl when the pawl rotates is improved.

In door latch device for vehicle, the extending arm preferably comprises a base end portion, a distal end portion, and an inclined portion. The base end portion is connected to the one of end portions of the coiled spring portion. The base end portion is a portion facing the first area of the abutted surface. The distal end portion is a portion which is provided at opposite side to the base end portion, and abuts against the second area of the abutted surface. The inclined portion is a portion which is inclined to the abutted surface so as to gradually closing to the abutted surface towards the distal end portion between the base end portion and the distal end portion. In this case, the inclined portion can be configured by whole or part of area from the base end portion to the distal end portion of the extending arm. As a result, a structure where the extending arm avoids abutting against the area having relatively high surface roughness and abuts against the area having low surface roughness can be constructed by using the inclined portion which is relatively easily formed in the extending arm.

In door latch device for vehicle, the inclined portion of the extending arm is preferably configured so as to be inclined to the abutted surface at an angle exceeding a preset minimum inclination angle in both a case where the pawl is at the first position and a case where the pawl is at the second position. A contact manner of the extending arm with respect to the abutted surface when the pawl is at the first position is different from that of the extending arm when the pawl is at the second position. To cope with the change, it is effective to set the inclined angle of the inclined portion exceeds the minimum inclination angle at both the first position and the second position. Therefore, regardless of a rotational position of the pawl, it becomes possible to make the extending arm contact with the abutted surface while the extending arm is always prevented from contacting with the area having relatively high surface roughness.

In door latch device for vehicle, the inclined portion is preferably formed by a preliminary bending for the extending arm. By the preliminary bending, the inclined portion is bent so as to be rotated in a direction towards the abutted surface about the base end portion from a reference state where the distal end portion is parallel to the abutted surface. The inclined portion can be easily formed in the extending arm by the preliminary bending.

In door latch device for vehicle, the inclined portion is preferably formed by another preliminary bending. By the preliminary bending, the inclined portion is bent beforehand and complexly so as to be rotated in a first bending direction towards the abutted surface and a second bending direction along the abutted surface about the base end portion from a reference state where the distal end portion is parallel to the abutted surface of the pawl. The inclined portion can be easily formed in the extending arm by this preliminary bending.

In door latch device for vehicle, it is preferable that the distal end portion of the extending arm is provided with a bending portion which is previously bent so as to project towards the second area of the abutted surface of the pawl, and a projectingly curved surface of the bending portion is brought into contact with the second area. Thus, it becomes possible to reduce a sliding resistance when the extending arm slides on the second area of the abutted surface when the pawl rotates by the projectingly curved surface of the bending portion.

In door latch device for vehicle, it is preferable that the abutted surface of the pawl is a section which is formed by press forming a metal plate in a plate thickness direction, and the first area is constituted by a fracture surface included in the section. Because the fracture surface formed by the press forming has very large irregularity, the present invention is particularly effective when being applied to a structure where the extending arm of the pawl return spring is brought into contact with the abutted surface which is formed by the press forming.

### (Actions and Effects)

As discussed above, according to the present invention, it has become possible to achieve an improvement of operability of the pawl which can engage with the latch rotating in the door closing direction by engaging with the striker.

### BRIEF DESCRIPTION OF DRAWINGS

FIG. 1 is a view for illustrating a door latch device for vehicle 100 as viewed from back of a vehicle when a pawl 120 is at a first position P1.

FIG. 2 is a cross sectional view of the door latch device for vehicle 100 taken along the line A-A of FIG. 1.

FIG. 3 is a view for illustrating the door latch device for vehicle 100 as viewed from back of the vehicle when the pawl 120 is at a second position P2.

FIG. 4 is a perspective view for illustrating the pawl 120 and a pawl return spring 130 of FIG. 1.

FIG. 5 is a plane view for illustrating the pawl return spring 130 before being assembled.

FIG. 6 is a view for illustrating an abutting state between an abutted surface 121 and an extending arm 132 of the pawl return spring 130 when the pawl 120 is at a first position P1 and a second position P2, respectively.

FIG. 7 is a view for illustrating an abutting state between the abutted surface 121 of the pawl 120 positioned at the first position P1 and the extending arm 132 of the pawl return spring 130 as viewed from Z1 direction in FIG. 6.

FIG. 8 is a view for illustrating an abutting state between the abutted surface 121 of the pawl 120 positioned at the second position P2 and the extending arm 132 of the pawl return spring 130 as viewed from Z2 direction in FIG. 6.

FIG. 9 is a view for illustrating a structure of an extending arm 232 which is a modified embodiment of the extending arm 132 in FIG. 7.

FIG. 10 is a view for illustrating a structure of an extending arm 332 which is a modified embodiment of the extending arm 132 in FIG. 7.

FIG. 11 is a view for illustrating a structure of an extending arm 432 which is a modified embodiment of the extending arm 132 in FIG. 7.

### DESCRIPTION OF EMBODIMENTS

An embodiment of the present invention will be described hereinafter with reference to the drawings. Note that in the drawings, vehicle left side and vehicle right side are indicated by arrows X1 and X2, respectively, and vehicle upper side and vehicle lower side are indicated by arrows Y1 and Y2, respectively. These directions can be applied for both a door latch device for vehicle before being assembled and the door latch device for vehicle after being assembled.

The door latch device for vehicle (hereinafter, it is simply referred to as “the door latch device”) 100 of this embodiment is installed in an area partitioned by a door outer panel and a door inner panel of a vehicle door together with a door lock device (not shown). Therefore, this door latch device can also be referred to as “latch mechanism of the door lock device”.

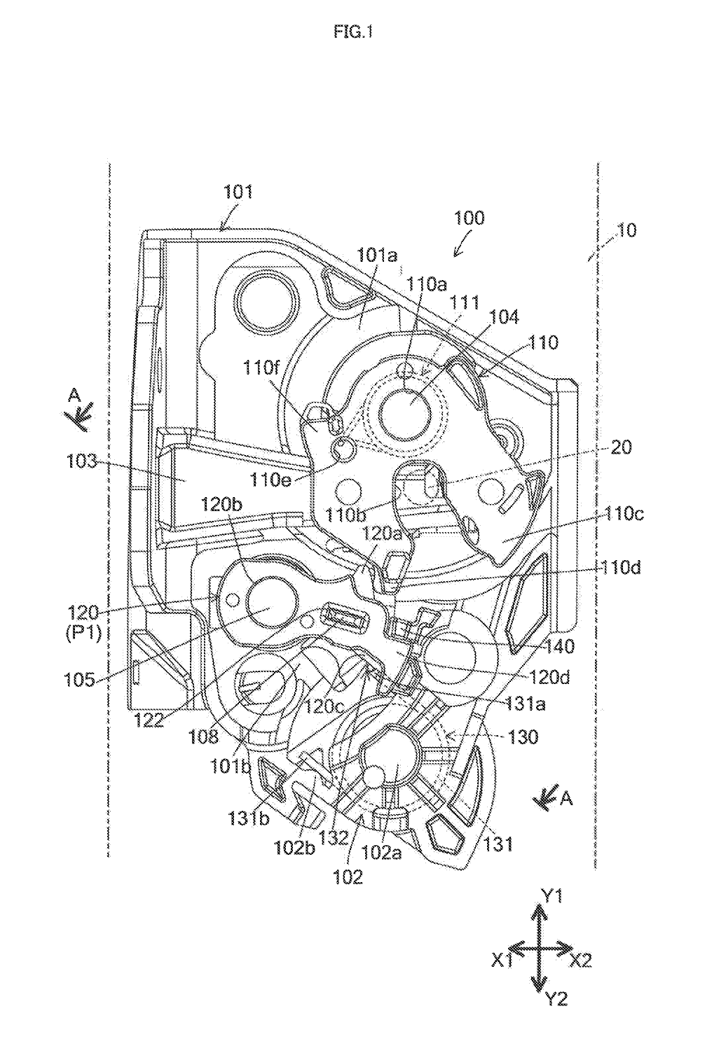

In FIG. 1 shows the door latch device for vehicle 100 which is installed to a vehicle door 10 positioned on the right side of a vehicle body as viewed from back of the vehicle with a base plate (a base plate 106 described hereinafter) removed from a body 101. The door latch device 100 is provided with the body 101 made of resin. A plurality of components are directly or indirectly attached to this body 101. The components include a metal latch 110, a latch return spring 111 made of spring steel, a metal pawl 120, a pawl return spring 130 made of spring steel, a stopper 140 made of rubber, and the like.

The body 101 is provided with a first accommodating section 101a, a second accommodating section 101b, a spring installation section 102, and a striker insertion groove 103. The latch 110 is accommodated in the first accommodating section 101a to be rotatable. The pawl 120 is accommodated in the second accommodating section 101b to be rotatable. The latch 110 is configured so as to be engageable with the pawl 120. For this purpose, the first accommodating section 101a and the second accommodating section 101b are communicated with each other in an area where the latch 110 and the pawl 120 are engaged with each other. The pawl return spring 130 is installed to the spring installation section 102. For this purpose, the spring installation section 102 is provided with a shaft portion 102a for holding a coiled spring portion 131 of the pawl return spring 130 and an locking portion (an locking projection) 102b for locking a body side end portion 131b of the coiled of spring portion 131. The striker insertion groove 103 is a groove extending horizontally along the lateral direction X1, X2, and is configured so that a well-known striker 20 (see two-dot chain line (imaginary line) in FIG. 1) provided on the vehicle body can enter the striker insertion groove 103. The striker 20 enters the striker insertion groove 103 at the time of closure of the vehicle door 10, and comes out of the striker insertion groove 103 at the time of the opening of the vehicle door 10. Noted that the striker 20 may be attached to the vehicle door 10 instead of the configuration in which the striker 20 is attached to the vehicle body. In this configuration, the door latch device 100 is attached to the vehicle body.

The latch 110 is provided with a mounting hole 110a, a striker holding grovel 10b, a half latch pawl 110c, a full latch pawl 110d, a spring locking hole 110e, and an engaging protrusion 110f. The latch 110 is rotatably supported by to a supporting shaft 104 mounted on the body 101. This latch 110 is configured to be pressed towards a door closing direction by engaging with the striker 20 when the vehicle door 10 is closed, and is configured to be constantly elastically biased in the clockwise direction of FIG. 1 towards a predetermined return position. In this case, the predetermined return position of the latch 110 is defined as a position where the engaging protrusion 110f is engaged with a protrusion (not shown) of the body 101. This latch 110 corresponds to “latch” of the present invention.

The latch return spring 111 is coaxially mounted to the supporting shaft 104. The latch return spring 111 is accommodated in the first accommodating section 101a of the body 101 together with the latch 110. One end portion of the latch return spring 111 is locked to the body 101, while the other end portion of the latch return spring 111 is locked to the spring locking hole 110e of the latch 110.

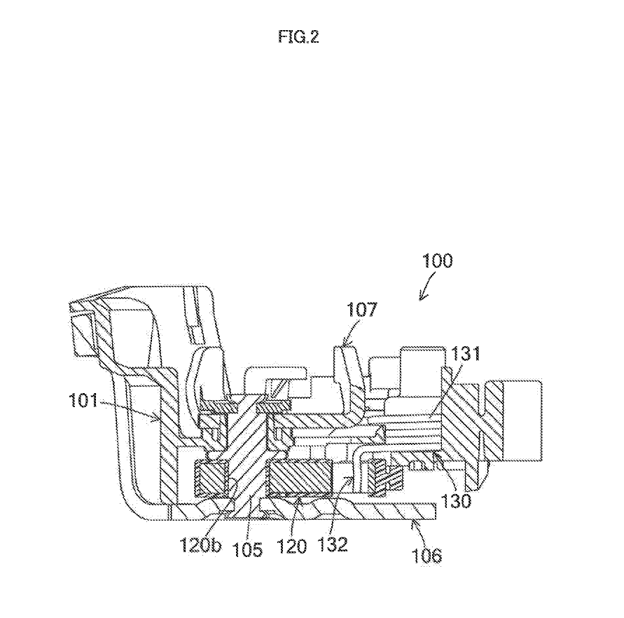

The mounting hole 110a is for mounting the latch 110 to the supporting shaft 104 so as to be rotatable. The striker holding groove 110b is a groove which is slidably engaged with the striker 20 at the time of opening and closing of the vehicle door 10. The striker holding groove 110b is configured so as to be able to hold the striker 20 in cooperation with the striker insertion slit (not shown) formed in the base plate (a base plate 106 shown in FIG. 2) provided in the body 101.

The half latch pawl 110c is configured so as to slidably engage with an engaging portion 120a of the pawl 120 when the vehicle door 10 is between an opened state thereof and a half-latched state thereof. In particular, when the vehicle door 10 is in the half-latched state, the rotation of the half latch pawl 110c in the clockwise direction of FIG. 1 (the rotation of the latch 110 towards the return position) is restricted by the engaging portion 120a of the pawl 120. The full latch pawl 110d is configured so as to be able to slidably engage with the engaging portion 120a of the pawl 120 when the vehicle door 10 is between an almost closed state thereof and a closed state thereof. In particular, when the door 10 is in the closed state, the rotation of the full latch pawl 110d in the clockwise direction of FIG. 1 (the rotation of the latch 110 towards the return position) is restricted by the engaging portion 120a of the pawl 120.

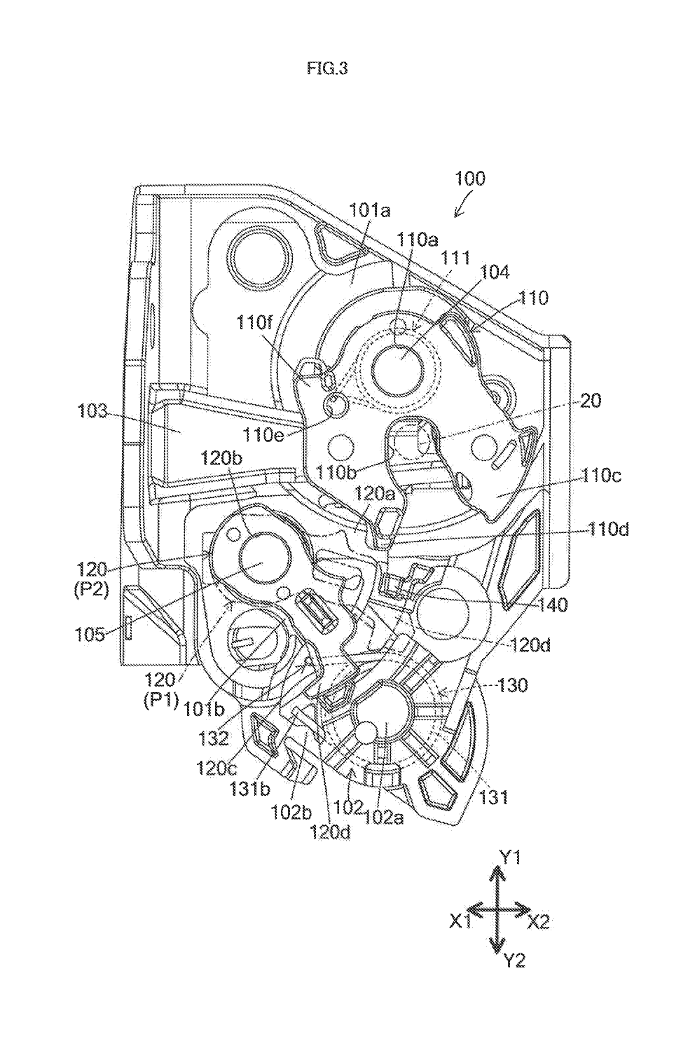

As shown in FIG. 3, the pawl 120 is rotatable between a first position P1 indicated by a two-dot chain line and a second position P2 indicated by a solid line about the supporting shaft 105. The pawl 120 is configured so as to prevent the rotation of the latch 110 in a door opening direction by making the engaging portion 120a engage with the latch 110 when the pawl 120 is at the first position P1. Thus, the rotation of the latch 110 towards the return position is prevented. On the other hand, this pawl 120 is configured so as to release the prevention of the rotation of the latch 110 in the door opening direction by releasing the engagement with the latch 110 at the second position P2. Thus allows the latch 110 to rotate towards the return position.

In addition to the engaging portion 120a, the pawl 120 is provided with a mounting hole 120b, a spring engaging portion 120c, and an engaging protrusion 120d. The mounting hole 120b is for mounting the pawl 120 to the supporting shaft 105. The pawl 120 is rotatably supported by the body 101 via the supporting shaft 105 which is attached to the mounting hole 120b. The spring engaging portion 120c is engaged with the pawl return spring 130. This spring engaging portion 120c is provided with a flat abutted surface 121. The pawl return spring 130 abuts with the abutted surface 121. For this reason, the pawl 120 is always (continuously) elastically biased towards the first position P1 by the pawl return spring 130. In this case, the first position P1 of the pawl 120 is defined as a position where the engaging protrusion 120d is engaged with the stopper 140 assembled to the body 101.

As shown in FIG. 2, the pawl 120 is mounted to the supporting shaft 105 so as to be relatively rotatable with respect to the supporting shaft 105. Additionally, a lift lever 107, which is operated in accordance with a door opening operation of an outside door handle and an inside door handle (not shown), is also assembled to the supporting shaft 105 so as to be relatively rotatable with respect to the supporting shaft 105. A protrusion 108 provided on the lift lever 107 is fitted into a through hole 122 provided in the pawl 120, and thereby the pawl 120 and the lift lever 107 are configured so as to be rotatable together with each other. Of course, this structure may be change to a structure where the pawl 120, the supporting shaft 105, and the lift lever 107 can rotate together with each other. Therefore, this lift lever 107 is operated at the time of door opening operation, and thereby the pawl 120 rotates in the clockwise direction from the first position P1 to the second position P2 against the elastic biasing force of the pawl return spring 130 together with the supporting shaft 105. In this case, a state where the pawl 120 is at the first position P1 is a initial state (also referred to as a “set state”) where the pawl return spring 130 is assembled to the body 101. On the other hand, a state where the pawl 120 is at the second position P2 is a state (also referred to as a “full state”) where deflection amount of the pawl return spring 130 is at the maximum within its use range and the elastic biasing force the pawl 120 receives from the pawl return spring 130 is at the maximum. The pawl 120 and the pawl return spring 130 correspond to the “pawl” and “pawl return spring” of the present invention, respectively.

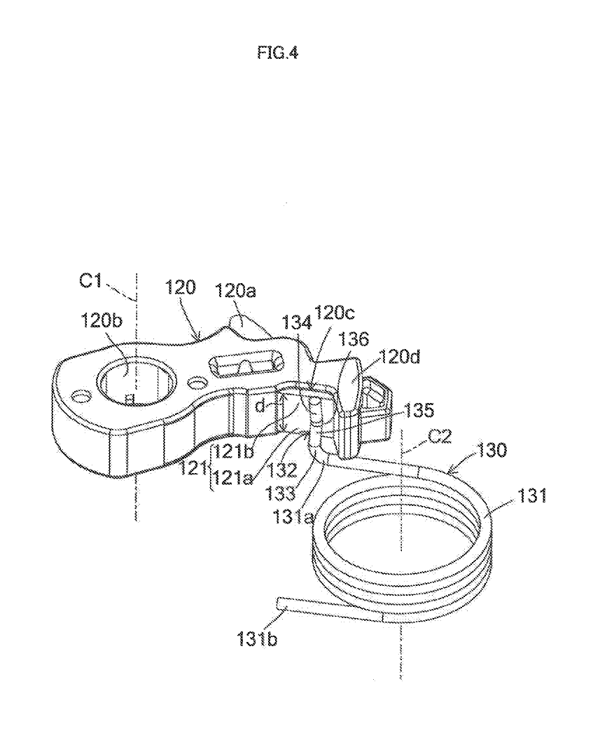

As shown in FIG. 4, the pawl return spring 130 is provided with a coiled spring portion 131 formed in a coiled state. The pawl return spring 130 is a spring which receives a torsional moment about the coil center (coil axis) C2 of the coiled spring portion 131. Namely, the pawl return spring 130 is a so-called “torsion coil spring”. The pawl return spring 130 is configured such that the coil center C2 of the coiled spring portion 131 extends parallel to the rotation center C1 of the pawl 120, and the coil center C2 and the rotation center C1 are spaced from each other in a radial direction of the coiled spring portion 131. This the pawl return spring 130 is provided with the extending arm 132 which extends along the abutted surface 121 of the pawl 120 from one of end portions (end portion 131a) of the coiled spring portion 131. In this case, the extending direction of the extending arm 132 is substantially coincident with the extending direction of the coil center C2. As a result, one of the end portions (end portion 131a) of the pawl return spring 130 has a substantially L-shape. The coiled spring portion 131 and the extending arm 132 correspond to “coiled spring portion” and “extending arm” of the present invention, respectively.

On the other hand, the pawl 120 is made by press forming a metal plate in a plate thickness direction. This press forming is carried out with a forming mold so that the metal plate becomes a predetermined shape after being sheared downward in FIG. 4. In this case, the abutted surface 121 provided on the spring engaging portion 120c of the pawl 120 is a section which is formed by the press forming of the plate. Therefore, this abutted surface 121 includes a fracture surface 121a and a shear plane 121b. The fracture surface 121a is formed in one of end portions of the abutted surface 121 in the plate thickness direction thereof, and the shear plane 121b is formed in the other of end portions of the abutted surface 121 in the plate thickness direction thereof. The fracture surface 121a is an irregular surface which has relatively high surface roughness (whose roughness is large). In contrast, the shear plane (shear surface) 121b is a surface which has lower surface roughness than the fracture surface 121a (roughness of the shear plane 121b is smaller). The fracture surface 121a and the shear plane 121b correspond to “first area” and “second area” of the present invention, respectively.

When the pawl 120 having the above configuration rotates about the supporting shaft 105 while receiving the elastically biasing force from the pawl return spring 130, a slip occurs between the spring engaging portion 102c (the abutted surface 121) and the extending arm 132 of the pawl return spring 130. The details will be described later, as described above, this slip occurs due to the arrangement where the coil center C2 of the pawl return spring 130 and the rotation center C1 of the pawl 120 are spaced from each other in the radial direction. If the extending arm 132 of the pawl return spring 130 comes into contact with the fracture surface 121a having large roughness in the abutted surface 121, the slip is easily prevented, and thereby operability (operating performance) of the pawl 120 at the time of a rotation of the pawl 120 is lowered. Therefore, in the present invention, this problem is solved by devising the shape of the extending arm 132 so that the extending arm 132 of the pawl return spring 130 does not contact with the fracture surface 121a of the abutted surface 121. Hereinafter, features of the shape of the extending arm 132 will be described in detail.

As shown in FIG. 4, the extending arm 132 of the pawl return spring 130 is provided with a base end portion 133, a distal end portion 134, and an inclined portion 135. The base end portion 133 is connected to one of the end portions (end portion 131a) of the coiled spring portion 131. The base end portion 133 is configured so as to face the fracture surface 121a of the abutted surface 121 of the pawl 120 while being spaced from the fracture surface 121a. The extending arm 132 is provided with the distal end portion 134 at opposite side to the base end portion 133. The extending arm 132 has a bending portion 136. The bending portion 136 can be formed by being previously bent in a “dogleg” manner such that the distal end portion 134 projects toward the shear plane 121b of the abutted surface 121 of the pawl 120. Then, the distal end portion 134 is configured so that the projectingly curved surface of the bending portion 136 is brought into contact with the shear plane 121b. In other words, a slippery area (which has a low sliding resistance) of the abutted surface 121 is selected for an area with which the extending arm 132 contacts (i.e., the extending arm 132 partically contacts with the slippery area). The inclined portion 135 is inclined to the abutted surface 121 at a predetermined angle between the base end portion 133 and the distal end portion 134 so that the inclined portion 135 gradually closes to the abutted surface 121 towards the distal end portion 134. The base end portion 133, the distal end portion 134, the inclined portion 135, and the bending portion 136 correspond to “base end portion”, “distal end portion”, “inclined portion”, and “bending portion” of the present invention, respectively.

The extending arm 132 having the above configuration is hardly prevented to slip against the abutted surface 121 by avoiding contact with the surface 121a, and thereby operability of the pawl 120 is improved at the time of a rotation of the pawl 120. Because the fracture surface formed by the press forming has very large irregularity, the present invention is particularly effective when being applied to a structure where the extending arm 132 of the pawl return spring 130a is brought into contact with a portion formed on the abutted surface 121 which is formed by the press forming. In addition, it is possible to reduce a sliding resistance when the extending arm 132 slides on the shear plane 121b of the abutted surface 121 when the pawl 120 rotates, because the bending portion 136 and the surface 121 come into contact with each other smoothly by bringing the projectingly curved surface of the bending portion 136 into surface contact with the surface 121. In addition, this bending portion 136 is positioned within the range of width (width d in FIG. 4) of the abutted surface 121. Therefore, even when the extending arm 132 slides in a direction of the width d of the abutted surface 121 at the time of rotation of the pawl 120, it is possible to prevent the distal end portion 134 of the extending arm 132 from disengaging with the abutted surface 121.

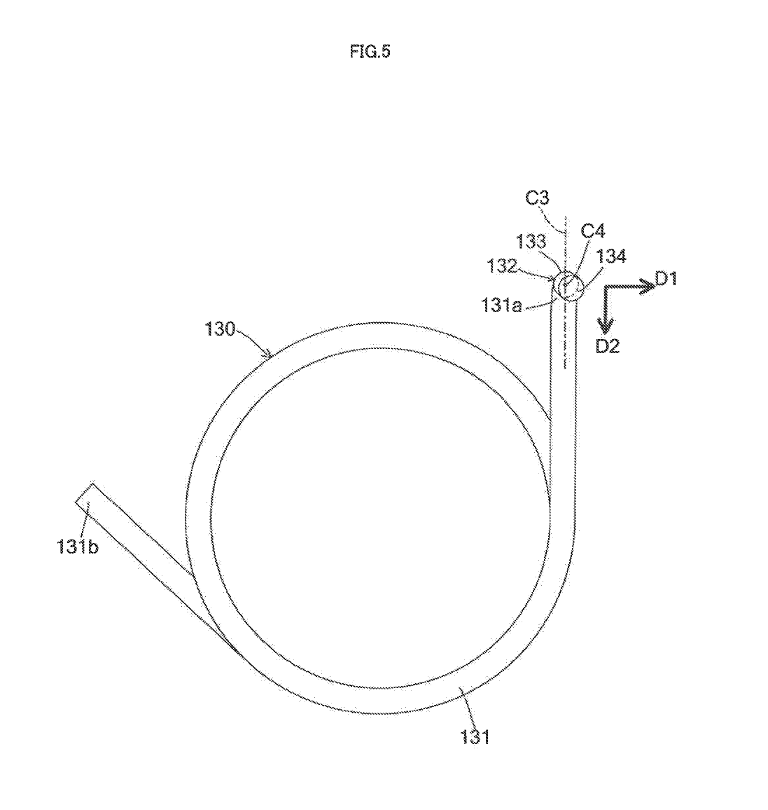

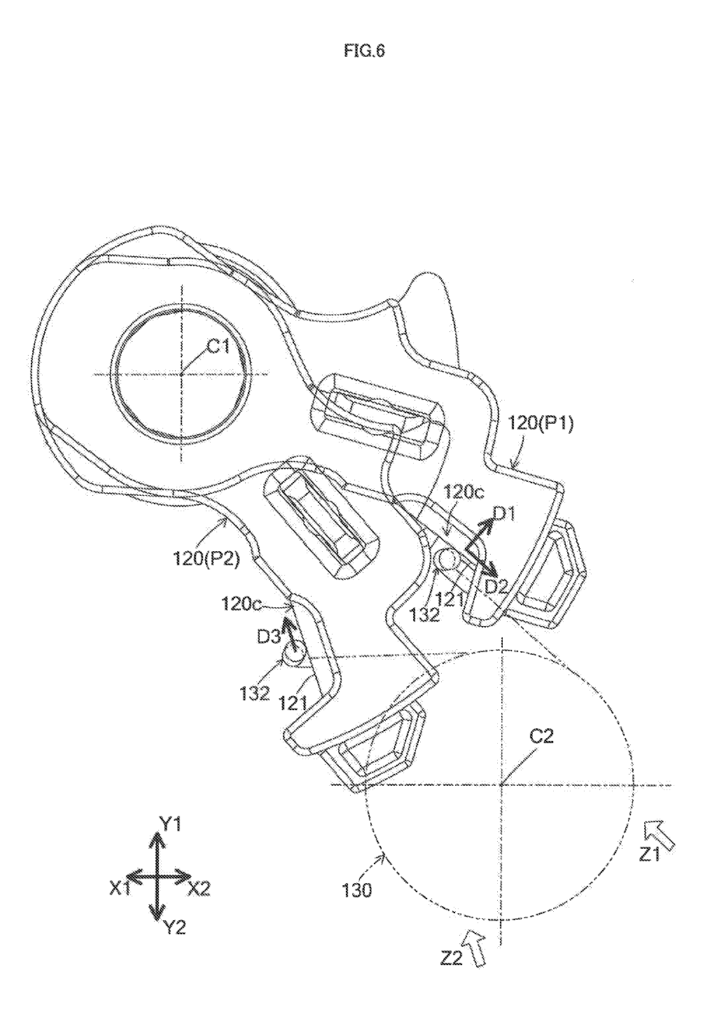

In the extending arm 132 having the above configuration, it is preferable to form the inclined portion 135 by a predetermined preliminary bending. As shown in FIG. 5, in this the preliminary bending, the distal end portion 134 is bent complexly and preliminary such that the distal end portion 134 is rotated in the first bending direction D1 and the second bending direction D2 about the base end portion 133 from a predetermined reference state. In this case, the “predetermined reference state” is defined as a state in which the distal end portion 134 is positioned on the reference axis C4 perpendicular to the axis C3 on which one of the end portions (the end portion 131a) of the coiled spring portion 131 is positioned. The first bending direction D1 can be defined as a direction which is perpendicular to both the axis C3 and the reference axis C4. The second bending direction D2 can be defined as a direction which is perpendicular to both the first bending direction D1 and the axis C3. In particular, as shown in FIG. 6, it is preferable to define the predetermined reference state as a state where the distal end portion 134 is parallel to the abutted surface 121 of the pawl 120 which is at the first position P1. In addition, it is preferable to define the first bending direction D1 as a direction toward the abutted surface 121 of the pawl 120 which is at the first position P1, and to define the second bending direction D2 as a direction along the abutted surface 121. As a result, a structure where the extending arm 132 avoids abutting against the fracture surface 121a and abuts against the shear plane 121b can be constructed by using the inclined portion 135 which is relatively easily formed in the extending arm 132 by the preliminary bending.

As shown in FIG. 6, the abutting position (contacting position) of the extending arm 132 against the abutted surface 121 of the pawl 120 is changed to the direction of the arrow D3 when the pawl 120 moves from the first position P1 to the second position P2. As a result, the slip occurs between the abutted surface 121 and the extending arm 132 as described above. In addition, in this case, an area of the extending arm 132 which is brought into contact with the abutted surface 121 of the pawl 120 is changed in a circumferential direction of the extending arm 132, when the pawl 120 is moved between the first position P1 the second position P2. In other words, a contact manner of the extending arm 132 with respect to the abutted surface 121 is changed in accordance with a rotational position of the pawl 120. Therefore, it is preferable to always prevent the extending arm 132 from contacting with the fracture surface 121a of the abutted surface 121 regardless of the change of the contact manner.

Therefore, in the present embodiment, the above preliminary bending can be carried out so that the inclined portion 135 is inclined to the abutted surface 121 at an angle exceeding a preset minimum inclination angle θ (min) in both a case where the pawl 120 is at the first position P1 and a case where the pawl 120 is at the second position P2.

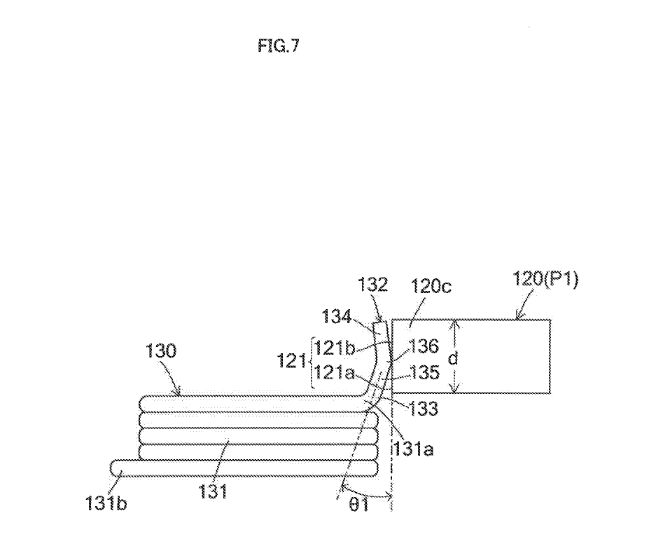

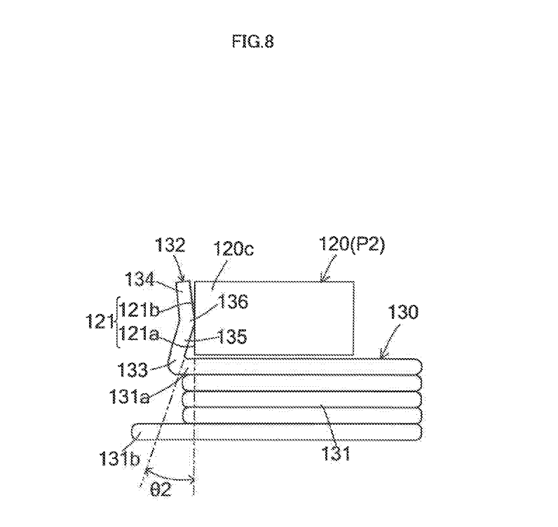

More specifically, as shown in FIG. 7, when the pawl return spring 130 is viewed from the Z1 direction (the direction along the abutted surface 121) in FIG. 6 with the pawl 120 positioned at the first position P1, the first inclination angle θ1 of the inclined portion 135 with respect to the abutted surface 121 is set to exceed the minimum inclination angle θ (min). Additionally, as shown in FIG. 8, when the pawl return spring 130 is viewed from the Z2 direction (the direction along the abutted surface 121) in FIG. 6 with the pawl 120 positioned at the second position P2, the second inclination angle θ2 of the inclined portion 135 with respect to the abutted surface 121 is set to exceed the minimum inclination angle θ (min). Noted that, the minimum inclination angle θ (min) is typically set based on an examination or the like carried out in advance so that the inclined portion 135 does not come into contact with the fracture surface 121a of the abutted surface 121 (i.e., the partical contact of the extending arm 132 against the shear plane 121b is maintained at all times) even if the extending arm 132 is elastically deformed at the time of the rotation of the pawl 120.

As a result, even if the contact manner between the abutted surface 121 and the extending arm 132 changes in accordance with the rotational position of the pawl 120, it is possible to reliably bring the extending arm 132 into contact with the abutted surface 121 (the shear plane 121b) while the extending arm 132 is prevented from contacting with the fracture surface 121a at all times, regardless of the change of the contact manner. As a result, when the pawl 120 is rotated between the first position P1 and the second position P2, the slip between the abutted surface 121 and the extending arm 132 occurs. However, the slip is smooth. Furthermore, the operability of the pawl 120 is not lowed. Namely, deterioration of operation feeling of the pawl 120 does not occur.

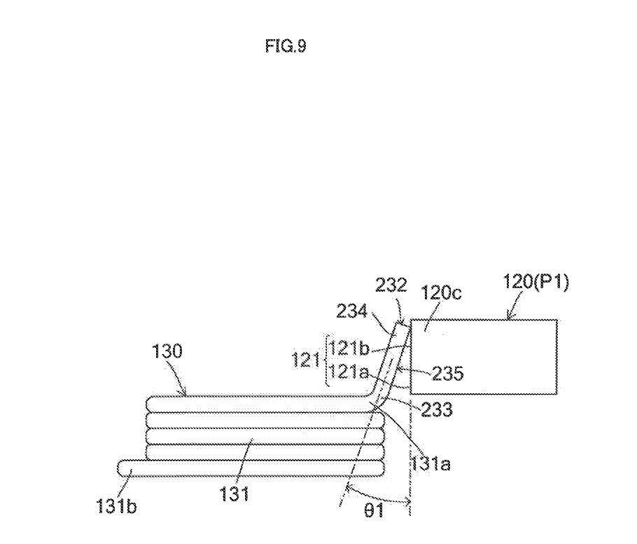

Note that, in view of the purpose of preventing the extending arm 132 of the spring 130 from contacting with the fracture surface 121a of the abutted surface 121, it is possible to adopt an extending arm whose shape is different from that of the above extending arm 132. For example, it is possible to adopt each of the extending arms shown in FIGS. 9-11, respectively.

The aforementioned extending arm 132 has a part which constitutes the inclined portion 135. However, in an extending arm 232 shown in FIG. 9, the whole arm area from the base end portion 233 to the distal end portion 234 corresponds to the inclined portion 235. That is, in this the extending arm 232, a portion corresponding to the bending portion 136 of the aforementioned extending arm 132 is omitted. This extending arm 232 is formed by a preliminary bending. In this preliminary bending, the distal end portion 234 is previously bent so that the distal end portion 234 is rotated in a direction (the first direction D1 shown in FIG. 6) towards the abutted surface 121 about the base end portion 233 from the reference state in which the distal end portion 234 is parallel to the abutted surface 121 of the pawl 120. According to this the preliminary bending, when the pawl 120 is at the first position P1, the first inclination angle θ1 of the inclined portion 235 with respect to the abutted surface 121 is set to exceed the minimum inclination angle θ (min). In addition, according to this preliminary bending, it is possible to set an inclination angle of the inclined portion 235 with respect to the abutted surface 121 to exceed the minimum inclination angle θ (min) in a case where the pawl 120 is at the second position P2. Thus makes it possible to prevent the extending arm 232 from abutting against the fracture surface 121a of the abutted surface 121.

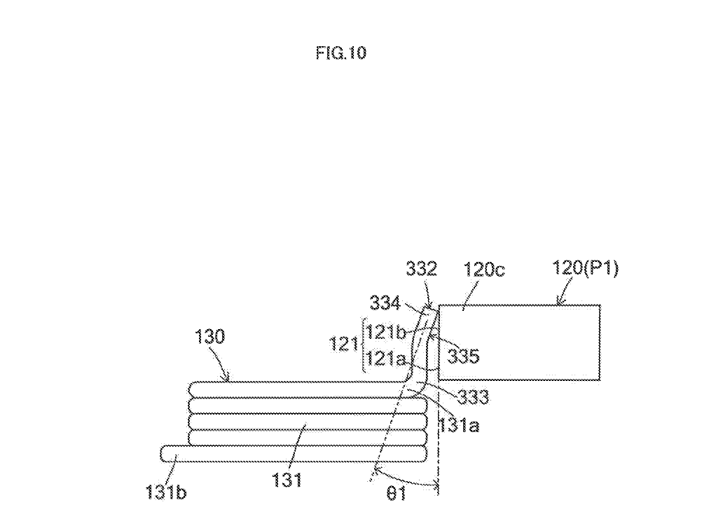

The aforementioned extending arm 132 is configured to include the inclined portion 135 on the base end portion 133 side. However, the extending arm 332 shown in FIG. 10 is provided with the inclined portion 335 on the distal end portion 334 side which is included in an area from the base end portion 333 to the distal end portion 334. The extending arm 332 can be also prevented from abutting against the fracture surface 121a of the abutted surface 121. Therefore, this extending arm 332 can achieve the same effects as the aforementioned extending arm 132.

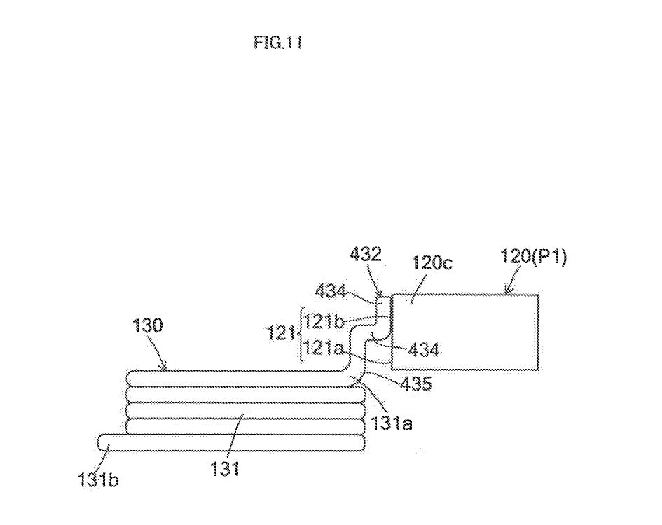

The aforementioned extending arm 132 is configured to include the inclined portion 135. However, the extending arm 432 shown in FIG. 11 is not provided with a portion corresponding to the inclined portion 335 in an area from the base end portion 433 to the distal end portion 434. Instead, the extending arm 432 is provided with a stepped portion 435. For example, it is possible to form the stepped portion 435 by bending an arm extending straight in a crank shape. The extending arm 432 can be also prevented from abutting against the fracture surface 121a of the abutted surface 121. Therefore, this extending arm 432 can achieve the same effects as the aforementioned extending arm 132.

The present invention is not limited to the typically embodiment described above, it is possible to adopt various applications and modifications. For example, the present invention can be carried out as following embodiments applying the above embodiment.

In the extending arm 132 having the configuration described above, an inclination condition where the inclined portion 135 is inclined to the abutted surface 121 at an angle exceeding the minimum inclination angle θ (min) is meet in both a case where the pawl 120 is at the first position P1 and a case where the pawl 120 is at the second position P2 has been described. However, the present invention may be configured so that the inclination condition is meet when the pawl 120 is at one of the first position P1 and the second position P2.

In the above door latch device for vehicle 100, the extending arm 132 of the pawl return spring 130 abuts against the abutted surface 121 which is formed by the press forming. However, of course, in the present invention, the contact object of the extending arm may be an abutted surface which is formed by a method other than the press forming. In this case, it is possible to form the extending arm so as to abut against an area having a relatively low surface roughness in the abutted surface.

In the present invention, it is possible to apply the essential structure of the above door latch device for vehicle 100 to each of vehicle doors of the vehicle. For example, the essential structure of the above door latch device for vehicle 100 can be applied to left and right doors for front seats of the vehicle, left and right doors for rear seats of the vehicle, rear door(back door) of the vehicle, and the like.

1. A door latch device for vehicle, comprising:
a latch configured to be rotated in a door closing direction by engaging with a striker;
a pawl rotatable between a first position and a second position about a supporting shaft, said pawl preventing said latch from rotating in a door opening direction by engaging with said latch at said first position, said pawl releasing a prevention of a rotation of said latch in said door opening direction by releasing an engagement with said latch at said second position; and
a pawl return spring abutting against an abutted surface provided on said pawl so as to elastically biases said pawl towards said first position;
wherein,
said pawl return spring comprising:
a coiled spring portion formed in a coiled state, said coiled spring portion having the coil center at a position which is spaced from the rotation center of said pawl; and
an extending arm extending along said abutted surface of said pawl from one of end portions of said coiled spring portion, said extending arm being configured so as to abut against a second area which is spaced from a first area having relatively high surface roughness in said abutted surface of said pawl.

2. The door latch device for vehicle according to claim 1,
wherein, said extending arm comprising:
a base end portion connecting to said one of end portions of said coiled spring portion, said base end portion facing said first area of said abutted surface;
a distal end portion provided at opposite side to said base end portion, said distal end portion abutting against said second area of said abutted surface; and
an inclined portion inclined to said abutted surface so as to gradually closing to said abutted surface towards said distal end portion between said base end portion and said distal end portion.

3. The door latch device for vehicle according to claim 2,
wherein, said inclined portion of said extending arm is configured so as to be inclined to said abutted surface at an angle exceeding a preset minimum inclination angle in both a case where said pawl is at said first position and a case where said pawl is at said second position.

4. The door latch device for vehicle according to claim 2,
wherein, said inclined portion is formed by a preliminary bending,
wherein, in said preliminary bending, said inclined portion is bent beforehand so that said inclined portion is rotated in a direction towards said abutted surface about said base end portion from a reference state where said distal end portion is parallel to said abutted surface.

5. The door latch device for vehicle according to claim 2,
wherein, said inclined portion is formed by a preliminary bending,
wherein, in said preliminary bending, said inclined portion is bent beforehand and complexly so that said inclined portion is rotated in a first bending direction towards said abutted surface and a second bending direction along said abutted surface about said base end portion from a reference state where said distal end portion is parallel to said abutted surface of said pawl.

6. The door latch device for vehicle according to claim 2,
wherein, said distal end portion of said extending arm is provided with a bending portion which is previously bent so as to project towards said second area of said abutted surface of said pawl,
wherein, a projectingly curved surface of said bending portion is brought into contact with said second area.

7. The door latch device for vehicle according to claim 1,
wherein, said abutted surface of said pawl is a section which is formed by press forming a metal plate in a plate thickness direction,
wherein, said first area is constituted by a fracture surface included in said section.
